(19) United States
(12) Patent Application Publication
(10) Pub. No.: US 2009/0008999 A1
(43) Pub. Date: Jan. 8, 2009

(54) DEVICE MAKING IT POSSIBLE TO SWITCH FROM ONE ELECTRIC SOURCE TO ANOTHER

(75) Inventors: Maurice CALLAC, Saint Renan (FR); Jean-Paul Artis, Plouzane (FR)

Correspondence Address: LOWE HAUPTMAN & BERNER, LLP, 1700 DIAGONAL ROAD, SUITE 300, ALEXANDRIA, VA, 22314, US

(73) Assignee: Thales, Neuilly Sur Seine (FR)

(21) Appl. No.: 12/168,203

(22) Filed: Jul. 7, 2008

(30) Foreign Application Priority Data
Jul. 6, 2007 (FR) 07 04909

(51) Int. Cl. H02J 3/38

(52) U.S. Cl. 307/51

(57) ABSTRACT

The present invention relates to a device making it possible to switch from one electric source to another. It comprises two electromechanical relays, each of the two relays being capable of supplying power current coming from one of the two sources. The two relays are connected to one another so that the current supply for controlling one of the relays prevents the current supply for controlling the other relay.

### RELATED APPLICATIONS

The present application is based on, and claims priority from, French Application Number 07 04909, filed Jul. 6, 2007, the disclosure of which is hereby incorporated by reference herein in its entirety.

### FIELD OF THE INVENTION

The present invention relates to a device making it possible to switch from one electric source to another. It applies notably in the field of electronics.

### BACKGROUND OF THE INVENTION

A meteorological radar makes it possible to locate precipitations such as rain, snow or hail, to measure their intensity and if necessary to identify the dangerous phenomena. Most meteorological radars are installed on the ground and often form part of a much wider meteorological monitoring network. But an increasing number of civil airborne applications are seeing the light, air transport being particularly interested in meteorological phenomena. A meteorological radar makes it possible to detect extensive volumic targets, which are the clouds, of which it must give the position, the size and degree of danger. Estimating the size of a cloud involves estimating its surface area, that is to say the maximum horizontal distance over which it extends, and estimating its elevation, that is to say the maximum vertical distance over which it extends. The estimation of the surface area notably draws benefit from the azimuth of the radar beam. The estimation of the elevation notably draws benefit from the scanning of the angle of elevation of the radar beam. In practice, a display console displays to the crew a simplified representation of the clouds, notably the most dangerous zones that must absolutely be skirted round. The radar antenna is usually at the front of the craft, in the aircraft nose. The angle of elevation is scanned mechanically, thanks to a motor which drives the antenna about a horizontal axis. The azimuth is also scanned mechanically, thanks to another motor which drives the antenna about a vertical axis. One of the technical problems that the present invention proposes to solve relates to these mechanical scanning functions of the antenna in angle of elevation and azimuth. Specifically, the modules that control their supply, rich in electronics, are sensitive elements from the point of view of reliability of the radar system. On long-haul aircraft notably, the level of availability required for the meteorological radar is extremely high. So it is necessary to make the elements that do not have sufficient reliability totally or partially redundant. The antenna in itself is a fairly simple element based on welded waveguides; it is not very prone to failures. The antenna support arm, although comprising two axis allowing rotary movements, is also a very simple element not very prone to failures. However, the electronic modules that control their supply are extremely complex elements, so are elements that are likely to break down.

One evident redundancy solution consists in a totally redundant architecture. Each rotation axis of the antenna has two motors, each of the two motors having a standalone module for controlling its supply. The two modules are incorporated into two supply lines that are certainly separated but parallel from the generators to the motors. Two motors and two supply control modules per rotation axis of the antenna are therefore necessary, so four motors and four supply control modules in all. Availability is then maximal. But this purely mechanical redundancy solution considerably complicates the design of the system and enormously increases the cost of the radar. The two chains must be totally separate so that the failure modes of one are not transmitted to the other. For example, if the failure mode corresponding to the case in which a motor is mechanically blocked has to be dealt with, it notably requires a costly, nonpermanent coupling of each motor with its shaft, a clutch system for example, allowing alternately the coupling and decoupling of the motor and of the rotation axis of the antenna. The final cost is unacceptable and the added complexity of this system in the end induces a reduction in reliability.

A known alternative solution consists in a partially redundant architecture, in order to reduce the cost of the system. Each rotation axis of the antenna has only one motor chosen for its technology providing maximum reliability, but has two modules making it possible to control its supply. The two modules are incorporated in supply lines that are only partially in parallel, notably they share an electromechanical relay making it possible to switch from one supply control module to another. One motor and two supply control modules per rotation axis of the antenna are therefore necessary, that is two motors and four supply control modules in all. Reliability is again extremely high, notably if the motors are carefully chosen motors offering by themselves a very high reliability rate. The relay performing the function of switching from one supply control module to another is a means of switching like another, chosen for its simplicity and therefore its reliability. But the relay constitutes an additional element shared by the two redundant supply lines of one and the same rotation axis of the antenna. Because of the relay, the two supply control modules are not standalone. Specifically, if the relay fails, none of the two supply lines is any longer usable and it is the whole scanning function about the said axis that is finally lost, and even probably the whole monitoring function of the radar.

### SUMMARY OF THE INVENTION

The object of the invention is notably to find a good compromise between cost and reliability. It involves using only one motor per rotation axis of the antenna, but preferably a motor providing a good level of reliability. Each motor may be supplied by two standalone control modules, the two supply modules being incorporated into parallel supply lines. It is therefore the supply of the motors that is made redundant. The switching from one supply line to another is carried out by using two separate synchronized relays, one relay being incorporated into each of the two supply lines. The failure of one of the relays does not therefore render both supply lines unusable, only the one containing the faulty relay. Accordingly, the subject of the invention is a device making it possible to switch from one electric source to another. It comprises two electromechanical relays, each of the two relays being capable of supplying power current coming from one of the two sources. The two relays are connected to one another so that the current supply for controlling one of the relays prevents the current supply for controlling the other relay.

Advantageously, the current for controlling one relay may pass through a commutator of the other relay while said other relay is not supplied with control current.

In one embodiment, the current supply for controlling one relay may be controlled by a switch placed between the electric source of which the other relay is capable of supplying the power current and the commutator of the other relay through which the current for controlling the relay passes.

In one embodiment, the commutators of the relay supplied with control current, through which the current for controlling the other relay cannot pass, supply power current coming from one of the two sources to an electric motor. The motor may be a brushless three-phase synchronous current motor driving an airborne meteorological radar antenna about an elevation or azimuth scanning axis.

The device may be used if one of the electric sources fails.

Further, the main advantages of the invention are that the two relays are connected together so that it is not possible to simultaneously activate both redundant supply lines. Furthermore, it allows the cushioning of the motor when the supply is switched off. Incorporated into the redundant supply lines, the relays are therefore themselves redundant. In addition, the invention makes it possible to switch only after the supply current is turned off. For all these reasons, the solution according to the present invention is particularly reliable.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIGS. 1a and 1b, via a block diagram, an illustration of an example of a redundant architecture for a meteorological radar that the invention makes it possible to apply;

FIG. 2, via a block diagram, an illustration of the same example as FIGS. 1a and 1b;

FIG. 3, via a detailed block diagram, an illustration of the same example as the previous figures.

### DETAILED DESCRIPTION OF THE INVENTION

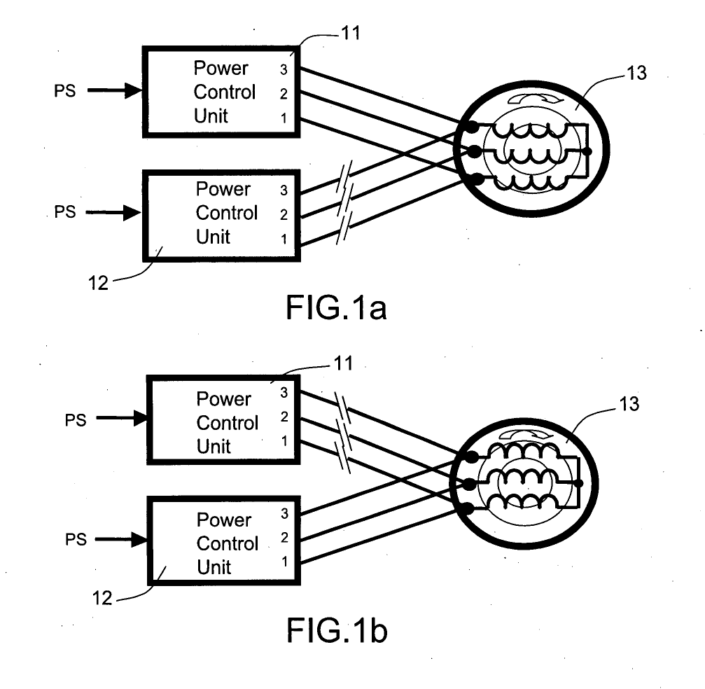

FIGS. 1a and 1b illustrate through a block diagram an example of a redundant architecture for a meteorological radar that the invention makes it possible to apply. In this embodiment, two supply control modules 11 and 12 may supply a motor 13. Hereinafter, the modules 11 and 12 will be respectively called “PCU 11” and “PCU 12” meaning “Power Control Unit”. For example, the motor 13 is a brushless three-phase synchronous current motor, reputed for its reliability. For example, the motor 13 is mounted on a support arm where it drives an antenna about an elevation and azimuth scanning axis. The support arm and the antenna are not represented in FIGS. 1a and 1b. To simplify the explanation, the operation about a single scanning axis will be described below. But the same principle may be used in an identical manner for the other axis. In this case, modules identical to PCU 11 and PCU 12 may simultaneously supply a second motor which drives the antenna about the second axis, the second motor also not being represented in FIGS. 1a and 1b.

The modules PCU 11 and PCU 12 are redundant in the sense that they both perform exactly the same functions. Notably, each of the modules PCU 11 and PCU 12 may actuate or stop the motor 13, by supplying it with a current called “power current” or by stopping this supply respectively. For this, the motor 13 being three-phase, each of the modules PCU 11 and PCU 12 is connected to the motor 13 by means of three contacts numbered 1, 2 and 3. As illustrated by flows “PS”, for “Power Supply”, the modules PCU 11 and PCU 12 are supplied simultaneously and permanently with electric current. But depending on the choice made, it is either the module PCU 11 that supplies the motor 13 as illustrated by FIG. 1a, or it is the module PCU 12 that supplies the motor 13 as illustrated by FIG. 1b. As explained below, the manner of controlling the module PCU 11 or PCU 12 that supplies the motor 13 is more particularly the subject of the present invention.

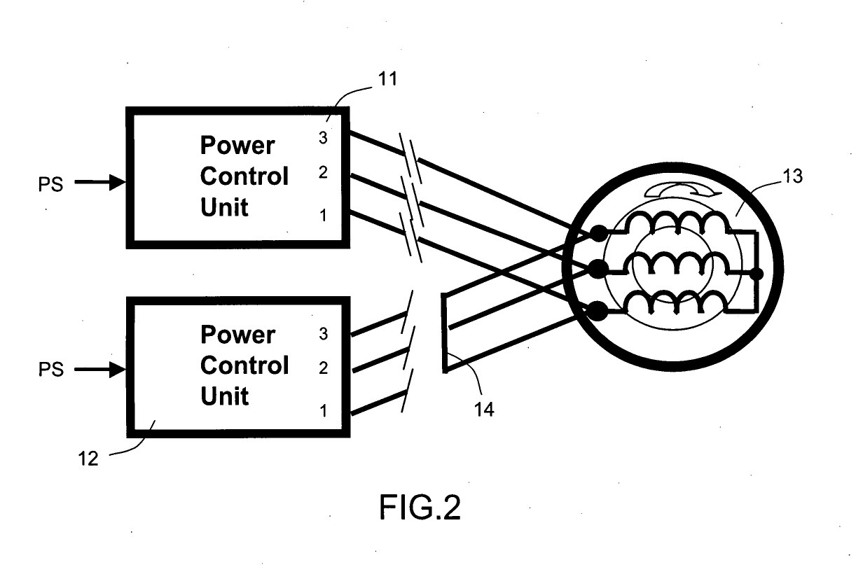

FIG. 2 illustrates, via a block diagram, the same example as FIGS. 1a and 1b when neither of the modules PCU 11 and PCU 12 supplies the motor 13. The present invention then advantageously makes it possible to connect the coils of the motor 13 together, as illustrated by a short circuit element 14. This short-circuiting of the coils has the effect of retarding the rotation about the axis when the antenna is still in rotation on inertia, or else of cushioning the rotation that may be induced by an external cause such as the movements or vibrations of the carrier. It should be noted that, despite everything, the modules PCU 11 and PCU 12 remain supplied with electric current, as illustrated by the flows PS.

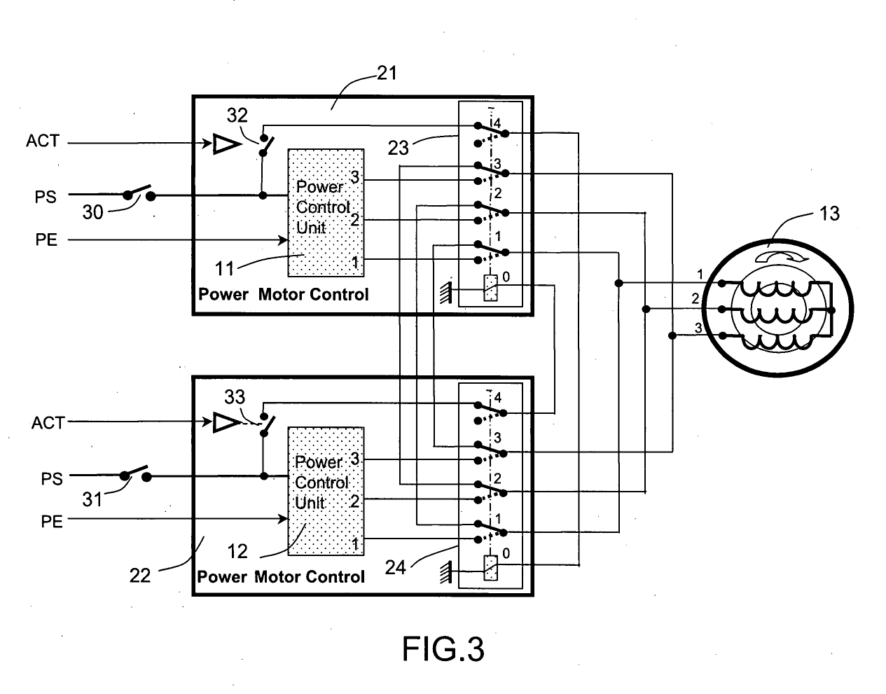

FIG. 3 illustrates, via a detailed block diagram, the same example of a redundant architecture for a meteorological radar as the previous figures.

FIG. 3 allows a better understanding of the principle according to the invention making it possible to control the module PCU 11 or PCU 12 that supplies the motor 13, and to better understand the short-circuiting of the motor 13 when neither of the two modules PCU 11 and PCU 12 is supplying it.

In order to have complete control of the operational safety of the system, the supply of the modules PCU 11 and PCU 12 can be controlled thanks respectively to switches 30 and 31. Hereinafter, the assumption is made that the switches 30 and 31 are permanently in the closed position, that is to say that the modules PCU 11 and PCU 12 are always supplied with electric current provided by the flows PS. They are therefore ready if necessary to supply the motor 13 with power current, but the motor 13 remains stopped so long as it is not really the case.

Two modules 21 and 22 particularly make use of the invention. They make it possible to control the motor 13. Hereinafter, they will be called PMC 21 and PMC 22 for “Power Motor Control”. The modules PMC 21 and PMC 22 respectively contain the modules PCU 11 and PCU 12 and electromechanical relays 23 and 24. The relays 23 and 24 each comprise a supply terminal marked 0 and four contacts marked 1 to 4. The supply terminal marked 0 corresponds to the supply of the excitation coil of the relay, hereinafter called “excitation terminal 0”. The contacts 1 to 4 correspond to two-position commutators: one position called “Normally closed” (top position in FIG. 3) and one position called “Normally open” (bottom position in FIG. 3). When an electric current is applied to the excitation terminal 0, the four commutators of the relay simultaneously switch from the top normally closed position to the bottom normally open position. When said electric current ceases to be applied to the excitation terminal 0, the four commutators of the relay simultaneously return to the top normally closed position. Said current is called “relay control current”, because it makes it possible to control the changes of position of the relay. It is a current generated from a low voltage. The contacts numbered 1 of the modules PCU 11 and PCU 12 are connected to the bottom normally open position of the commutators corresponding to the contacts numbered 1 of the relays 23 and 24 respectively. The contacts numbered 1 of the relays 23 and 24 are both connected to a contact numbered 1 of the motor 13. The contacts numbered 2 of the modules PCU 11 and PCU 12 are connected to the normally open position of the commutators corresponding to the contacts numbered 2 of the relays 23 and 24 respectively. The contacts numbered 2 of the relays 23 and 24 are both connected to a contact numbered 2 of the motor 13. The contacts numbered 3 of the modules PCU 11 and PCU 12 are connected to the bottom normally open position of the commutators corresponding to the contacts numbered 3 of the relays 23 and 24 respectively. The contacts numbered 3 of the relays 23 and 24 are both connected to a contact numbered 3 of the motor 13. In this manner, the top normally closed position of the commutators in a relay corresponds to a situation in which the module PCU situated in the same module PMC as the relay cannot supply the motor 13. Reciprocally, the bottom normally open position of the commutators in a relay corresponds to a situation in which the module PCU situated in the same module PMC as the relay can potentially supply the motor 13. For a full understanding of what follows, the assumption is made that initially, all the commutators of the relays 23 and 24 are in the top normally closed position, that is to say that the relays 23 and 24 do not receive any control current.

In a first time, a command to activate the module PMC 21 is passed by sending, as illustrated in FIG. 3, a first flow ACT entering the module PMC 22. This activation command advantageously makes it possible to set the switch 33 placed in the module PMC 22 in the closed position and advantageously to supply the excitation terminal 0 of the relay 23 in the module PMC 21 via the commutator corresponding to the contact 4 of the relay 24, this commutator advantageously being in the top normally closed position. All the commutators of the relay 23 then switch simultaneously to the bottom normally open position. The commutators 1, 2 and 3 of the relay 23 in the bottom normally open position thereby allow the supply of the motor 13 via the module PCU 11, while the commutator 4 of the relay 23 in the bottom normally open position prevents the supply of the excitation terminal 0 of the relay 24, which therefore sees all its commutators forced to remain in the top normally closed position. Notably, a possible command to activate the PMC 22 that would be passed to the PMC 21, as illustrated by a second flow ACT entering the PMC 21, which makes it possible to set a switch 32 placed in the module PMC 21 in the closed position, has no effect on the system. Therefore, only the module PCU 11 is ready to supply the motor 13, the module PCU 12 is barred from any possibility of supplying the motor 13. But the motor 13 is, for the moment, still stopped. In a second time, a command PE for “Power Enable” is passed to the module PCU 11. It makes it possible to truly supply the motor 13. The motor 13 then begins to rotate, driving the antenna of the radar. It should be noted that the supply of a power current to the motor 13 does actually occur in a second time, while the commutators of the relay 23 are in their stable bottom normally open position, which preserves the contacts of the relay 23. In addition to the fact that this precaution makes it possible to significantly increase the service life of the relay 23, its other value is that it makes a failure infinitely unlikely that could result from the fact that the commutators of the relay 23 remain stuck and that would culminate in the feared situation of absence of motor control. In the same manner, the supply of the motors is also stopped via the command PE passed to the module PCU 11 while the contacts of the relay 23 are still in their stable bottom normally open position.

The assumption is now made that the relay 23 receives no more control current by suppression of the flow ACT in the PMC 22 and that all its commutators have therefore returned to the top normally closed position.

Reciprocally, the activation command passed to the module PMC 21 advantageously makes it possible in a first time to set the switch 32 placed in the module PMC 21 in the closed position and advantageously to supply the contact 0 of the relay 24 in the module PMC 22 via the commutator corresponding to the contact 4 of the relay 23, this commutator advantageously being in the top normally closed position. All the commutators of the relay 24 then switch simultaneously to the bottom normally open position. The commutators 1, 2 and 3 of the relay 24 in the bottom normally open position thereby allow the supply of the motor 13 via the module PCU 12, while the commutator 4 of the relay 24 in the bottom normally closed position bars the supply of the excitation coil 0 of the relay 23 which therefore sees all its commutators forced to remain in the top normally closed position. Notably, an activation command of the module PMC 21 that would be passed to the module PMC 22 would have no effect on the system. Therefore, only the module PCU 12 is ready to supply the motor 13, the module PCU 11 is barred from any possibility of supplying the motor 13. But the motor 13 is still stopped. In a second time, a command PE is passed to the module PCU 12. It makes it possible to really supply the motor 13. The motor 13 then begins to rotate, driving the antenna of the radar. It should be noted that the supply of a power current to the motor 13 is indeed made in two times, while the commutators of the relay 24 are in their stable bottom normally open position, which preserves the contacts of the relay 24 and limits the risk of seeing its contacts remain stuck.

It can be understood easily from the foregoing that the activation commands must not be passed simultaneously to the module PMC 21 and to the module PMC 22. It is either one or the other or neither of the two.

By using two relays 23 and 24 that are standalone and synchronized instead of using a single relay, the present invention ensures that the relay that has not failed, for example whose supply of the excitation terminal is turned off, is always available for switching from one PCU module to the other in total safety. For example, if the module PCU 11 or the excitation coil of the relay 23 supplies the motor 13 and then fails or is turned off respectively, it is sufficient to stop the activation command on the module PMC 22 in order to open the switch 33 and to pass the activation command to the module PMC 21 in order to close the switch 32. And it is then necessary that the relay 23 returns to normally closed so that the relay 24 can switch to the bottom normally open position when the switch 32 closes. Therefore, even if the failure originates from the relay 23, it is always possible to connect the motor 13 to the module PCU 12. The relay is therefore no longer a critical component in a redundant system according to the invention. Furthermore, in order to understand the invention well, it may be useful to note that the currents cross in the modules PMC 21 and PMC 22, in order to synchronize the relays 23 and 24 so that they are never in the bottom normally open position at the same time. At a given moment, one of the two relays is in the top normally closed position, while the other is allowed to be in the bottom normally open position. In order to understand the invention well, it may also be useful to note the value of the contacts numbered 4 of the relays 23 and 24: by authorizing or barring the transit from one PMC module to the other of the currents for controlling the relays, they make it possible to synchronize the relays.

Furthermore, when the activation commands are both disabled or when the modules PCU 11 and PCU 12 are not supplied because the switches 30 and 31 are open, then all the commutators of the relays 23 and 24 are in the top normally closed position. It should be noted that the coils of the motor 13 are then in short circuit, according to FIG. 2. Advantageously this has the effect of slowing the rotation about the axis when the antenna is still rotating on inertia, or else of cushioning the rotation that may be induced by an external cause such as the movements or the vibrations of the carrier.

In the example described in the figures of this application, the invention makes it possible to make redundant the supply of a motor of an airborne meteorological radar antenna, in order to remedy the cases of failure of the supply. But this example is not limiting. The invention may be applied in any field requiring a double electric supply, whether it be for a motor or for any other electric device. The invention may also make it possible to switch from one supply to another for reasons other than reasons of failure.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. A device for switching from one electric source to another, comprising:
two electromechanical relays, each of the two relays being capable of supplying power current coming from one of the two sources, the two relays being connected to one another so that the current supply for controlling one of the relays prevents the current supply for controlling the other relay.

2. The device as claimed in claim 1, wherein the current for controlling a relay passes through a commutator of the other relay while said other relay is not supplied with control current.

3. The device as claimed in claim 2, wherein the supply with current for controlling a relay is controlled by a switch placed between the electric source of which the other relay is capable of supplying the power current and the commutator of the other relay through which the current for controlling the relay passes.

4. The device as claimed in claim 3, which is used in the case of failure of one of the electric sources.

5. The device as claimed in claim 3, wherein the commutators of the relay supplied with control current, through which the current for controlling the other relay cannot pass, supply power current coming from one of the two sources to an electric motor.

6. The device as claimed in claim 5, wherein the motor is a brushless three-phase synchronous current motor.

7. The device as claimed in claim 5, wherein the motor drives an antenna about an elevation or azimuth scanning axis.

8. The device as claimed in claim 7, wherein the antenna is a radar antenna.

9. The device as claimed in claim 8, wherein the radar is a meteorological radar.

10. The device as claimed in claim 8, wherein the radar is airborne.
